(19) United States
(12) Patent Application Publication
(10) Pub. No.: US 2006/0229810 A1
(43) Pub. Date: Oct. 12, 2006

(54) GPS device and method for displaying weather data

(76) Inventors: John Cross, Overland Park, KS (US); Scott Nyhart, Shawnee, KS (US); Richard Ball, Overland Park, KS (US); John DeCastro, Lenexa, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/103,164

(22) Filed: Apr. 11, 2005

(51) Int. Cl. G01C 21/00

(52) U.S. Cl. 701/213; 701/200

(57) ABSTRACT

A GPS device and method for associating current and forecasted geo-referenced weather data with location data in a hand-held ruggedized GPS device having an integrated weather data receiver, wherein the weather data can be displayed alone, particularly on larger scales, or in conjunction with the location data.

### BACKGROUND OF THE INVENTION

1. Field of the Invention

The present invention relates broadly to hand-held electronic navigation and travel aids. More particularly, the present invention concerns a GPS device and method for associating current and forecasted geo-referenced weather data with location data in a hand-held ruggedized GPS device having an integrated weather data receiver, wherein the weather data can be displayed alone, particularly on larger scales, or in conjunction with the location data.

2. Description of the Prior Art

Outdoor enthusiasts, such as sportsmen, vacationers, and athletes, increasingly use hand-held electronic global positioning system (GPS) devices to navigate while afield. Commonly-available GPS devices typically include at least a processor, a receiver, and an antenna for receiving position signals from a plurality of known locations (e.g., from satellites in orbit) and, through a process of geometric triangulation, determining the relative location of the GPS device in terms of latitude, longitude, and even altitude. All such devices allow users to display their own current location, and many allow users to designate or otherwise create and display waypoints, trails, tracks, and other geo-referenced indicators corresponding to previous or other locations.

It is often desirable to access weather data while in the field, especially detailed information regarding current or forecasted severe weather conditions that could pose a threat to safety. It is known to download weather data via the Internet, from either a free site or a subscription service. Unfortunately, this solution requires a hard or wireless (e.g., wifi or gprs) connection to access the Internet, and special software running on a desktop computer, laptop computer, or personal digital assistant (PDA) to read the weather data. Such access and computing power is typically not available or not practical in the field, particularly for those traveling on foot.

It is also known to provide a PDA with means for receiving data via external peripheral devices. The data may be received through a hard or wireless (e.g., Bluetooth) connection; and the external peripheral devices may include a GPS receiver and a satellite radio receiver. Weather information can be received, for example, via an XM satellite radio weather channel, though this requires a decoder in order to make the data from the XM WX satellite weather service available for viewing on the handheld display device. Unfortunately, this solution suffers from a number of problems and disadvantages as well, including, for example, that the PDA is an undedicated broadly capable portable computing device which is typically relatively expensive to own and operate. Furthermore, PDAs are not designed for and may not survive use in relatively harsh operating conditions (e.g., physical shock or impact; dust or other particulate matter; rain or other moisture or even submersion; and extreme hot or cold temperatures), which can be of particular concern given their substantial cost. The prior art's reliance on external peripheral receiver devices, which are themselves bulky and expensive, is therefore not appropriate or practical for use in harsh operating conditions or use while on the move.

Due to these and other disadvantages in the prior art, a need exists for a portable, hand-held GPS device capable of associating weather data with location data.

### SUMMARY OF THE INVENTION

The present invention overcomes the above-described and other disadvantages in the prior art by providing a GPS device and method for associating current and forecasted geo-referenced weather data with location data in a hand-held ruggedized GPS device having an integrated weather data receiver, wherein the weather data can be displayed alone, particularly on larger scales, or in conjunction with the location data.

In a preferred embodiment, the GPS device broadly comprises a housing; a GPS unit; an input interface; a processor; an output display; a weather data receiver; an internal weather data memory; and a power supply. The GPS device as a whole is preferably appropriately designed and constructed so as to be lightweight, rugged, waterproof, and otherwise resistant to and protective against the relatively harsh operating conditions that would likely be encountered while in the field. Most or all of the aforementioned components are, to the greatest extent possible, located within and enclosed by the protective housing, i.e., fully integrated.

The weather data receiver is adapted and operable to receive the weather data from a suitable weather data service, and is preferably fully integrated into the GPS device and protectively enclosed within the housing. In one contemplated implementation, the weather data receiver is a broadly capable satellite radio or other receiver operable to receive a large number of information and entertainment channels. In this implementation, the device also includes a selection mechanism for selecting a particular channel from among the large number of channels, a display for communicating the particular channel currently selected, and high-quality speakers for listening to audio programming.

In another contemplated implementation, the weather data receiver is narrowly adapted to the specific task of receiving only weather data from one or a relatively few weather data channels, thereby eliminating or minimizing any need for the aforementioned user-accessible selection device, display, or high-quality speakers and thereby lowering manufacturing costs, reducing power consumption, and reducing size and weight.

The weather data received and made available to the user of the GPS device preferably includes Doppler radar, preferably high resolution NEXRAD Doppler radar; severe weather storm tracking; precipitation information, including precipitation type; lightning information; and country warnings. The weather data preferably further includes surface observation information; surface analysis weather maps; National Weather Service (NWS) forecasts; city forecasts; hurricane tracking; and surface wind speed and direction information.

As mentioned, the weather data is preferably geo-referenced so that it can be displayed in conjunction with the location data. Thus, the weather data can be accurately overlayed onto street maps, topographic maps, aerial photographs, satellite photographs, and other geo-referenced images. The present invention preferably allows for larger scales than are normally needed for displaying navigation data on a GPS device in order to accommodate weather data with relatively large maximum resolutions and to display developing weather patterns that are more than a relatively short distance away from the user's current location.

Thus, it will be appreciated that the GPS device and method of the present invention provide a number of substantial advantages over the prior art, including, for example, allowing a user to access weather data while in the field, including detailed information regarding current and forecasted severe weather conditions that might pose a threat to the user's safety. This feature is fully adapted for and integrated into the GPS device, making it a less expensive, more rugged, more portable, and generally more appropriate and practical solution than is provided for by the prior art.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a block-diagram depiction of a preferred embodiment of a GPS device of the present invention;

FIG. 2 is a depiction of weather data displayed on a relatively large scale;

FIG. 3 is a depiction of weather data and location data displayed on a relatively small scale; and

FIG. 4 is a flowchart of steps involved in operation of the GPS device of FIG. 1.

### DETAILED DESCRIPTION OF THE PREFERRED EMBODIMENT(S)

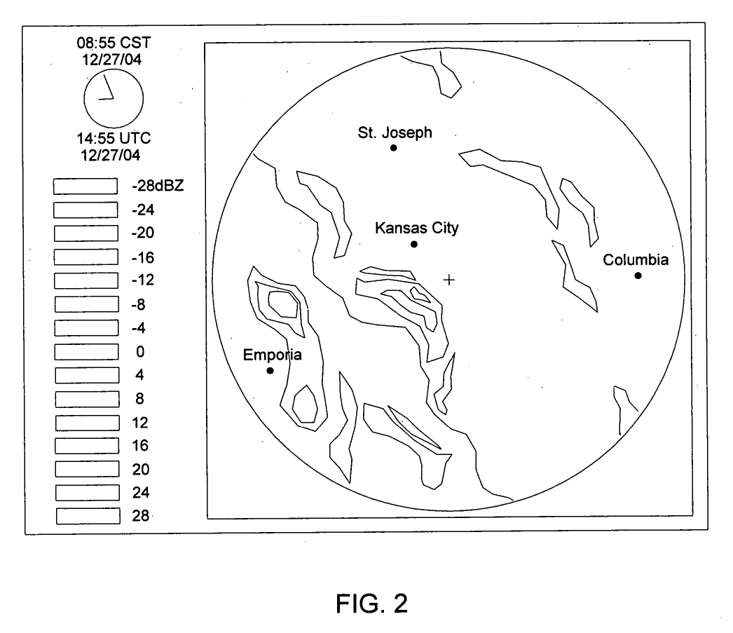

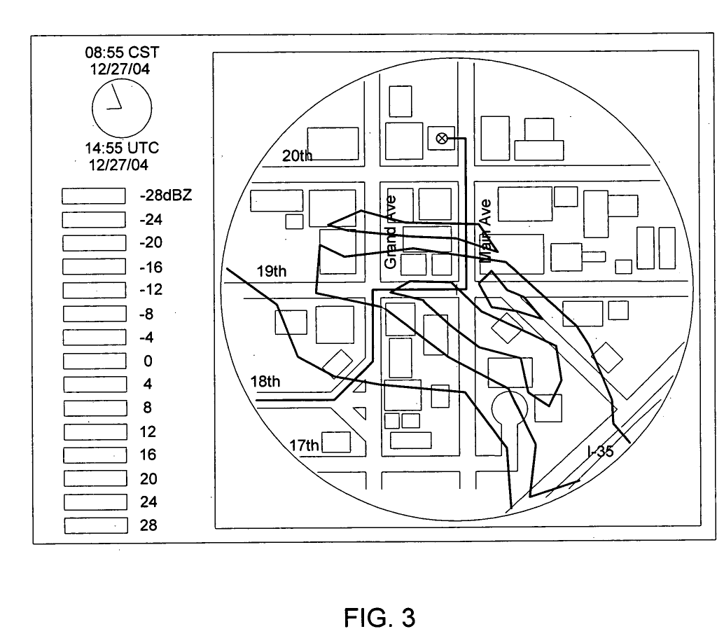

With reference to the figures, a GPS device 10 and method are herein described, shown, and otherwise disclosed in accordance with the preferred embodiment(s) of the present invention. More specifically, the present invention concerns a GPS device 10 and method for associating current and forecasted geo-referenced weather data, both in static and animated formats, with location data in a hand-held ruggedized GPS device having an integrated weather data receiver, wherein the weather data can be displayed alone, particularly on larger scales (see FIG. 2), or in conjunction with the location data (see FIG. 3).

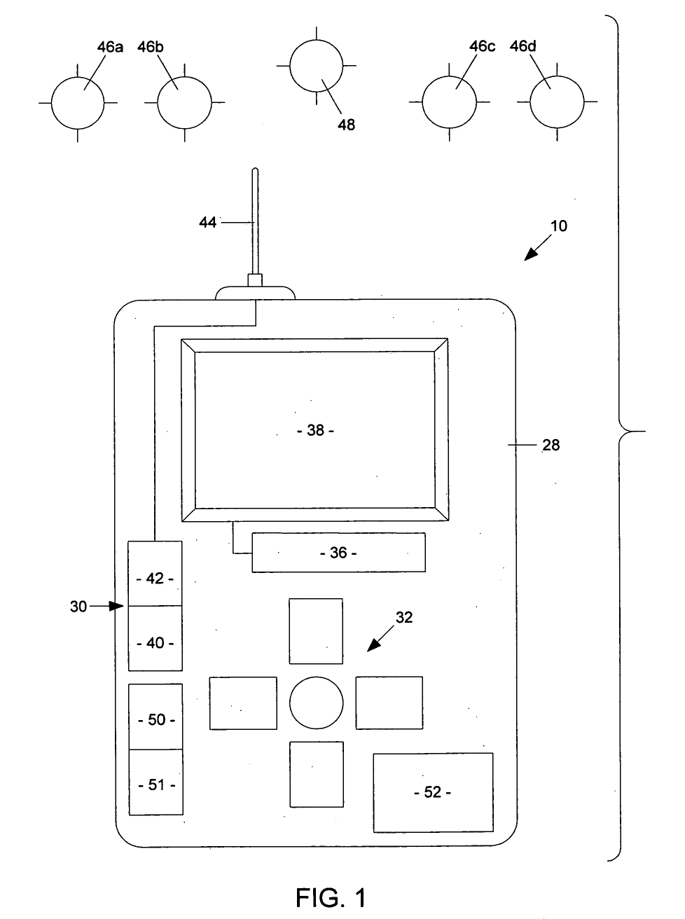

Referring to FIG. 1, a preferred embodiment of the GPS device 10 broadly comprises a housing 28; a GPS unit 30; an input interface 32; a processor 36; an output display 38; a weather data receiver 50; an internal weather data memory 51; and a power supply 52. It will be appreciated that GPS technology for determining location is well-known to those with ordinary skill in the art, and therefore the present disclosure focuses primarily on the claimed features that comprise the present invention rather than on said basic technology.

The GPS device 10 as a whole is preferably appropriately designed and constructed so as to be lightweight, rugged, waterproof, and otherwise resistant to and protective against the relatively harsh operating conditions that would likely be encountered while in the field, including, for example, physical shock or impact; dust or other particulate matter; rain or other moisture or even submersion; and extreme hot or cold temperatures. The housing 28 is therefore preferably constructed of an appropriately strong and durable yet lightweight material, such as, for example, high impact plastic, and made substantially sealable against intrusion by particulates and water. Most or all of the other aforementioned components of the GPS device 10 are fully, or to the greatest extent possible, located within an internal area defined by the housing 28, and are therefore substantially enclosed by the protective housing 28, i.e., fully integrated. This is in contrast to the prior art which uses relatively fragile and expensive computing devices and similarly fragile and expensive external, unintegrated peripheral receiver devices which are not appropriate or practical for use in harsh operating conditions or use while on the move.

The GPS unit 30 broadly includes at least a GPS processor 40, a GPS receiver 42, and an antenna 44 for, in a conventional manner, receiving signals from a plurality of known locations 46a,46b,46c,46d (e.g., satellites in orbit) and, through a process of geometric triangulation, determining the relative location of the GPS unit 30. Such location may include latitude, longitude, and even altitude.

The input interface 32 allows the user to enter information or make selections when prompted or otherwise appropriate. As such, the input interface 32 may take any suitable form and use any suitable input technology such as, for example, keypad, touch-screen, or scroll-wheel technologies. The processor 36 performs basic operating functions of the GPS device 10, including, for example, appropriately conditioning information, such as the weather data discussed below, for display. The output display 38 allows the GPS device 10 to communicate with the user, including displaying information and, when appropriate, presenting selections and/or prompting the user to make selections or otherwise enter input using the input interface 32. As such, the output display 38 may take any suitable form and use any suitable technology such as, for example, LCD technology. The output display 38 is, however, preferably at least a QVGA screen, with approximately at least 320 pixels×240 pixels or the equivalent, and with approximately at least 640×480 resolution or the equivalent; and is more preferably a VGA screen.

The weather data receiver 50 is adapted and operable to receive the weather data from a suitable weather data service, and is preferably fully integrated into the GPS device 10 and protectively enclosed within the housing 28. As such, the weather data receiver 50 may be, for example, a satellite radio receiver operable to receive data from one or both of the XM or Sirius satellite radio services via an orbiting satellite radio satellite 48; a gsm/gprs telephone; a satellite telephone; or other suitable technology. It is contemplated, for example, that the weather data receiver 50 may be an XM satellite radio receiver for receiving the XM WX satellite weather service.

In one contemplated implementation, the weather data receiver 50 is a broadly capable satellite radio receiver operable to receive a large number of information and entertainment channels. In this implementation, the device 10 also includes a selection mechanism, which may be provided by the input interface 32, for selecting a particular channel from among the large number of channels; a display, which may be provided by the output display 38, for communicating the particular channel currently selected; and high-quality speakers for listening to audio programming.

In another contemplated implementation, the weather data receiver 50 is narrowly adapted to the specific task of receiving only weather data from one or a relatively few weather data channels, thereby eliminating or minimizing any need for including additional components or for adapting the existing components to provide the aforementioned user-accessible selection device, display, or high-quality speakers, and thereby lowering manufacturing costs, reducing power consumption, and reducing size and weight of the device 10.

The weather data received and made available to the user of the GPS device 10 preferably includes Doppler radar, preferably high resolution NEXRAD Doppler radar; severe weather storm tracking; precipitation information, including precipitation type; lightning information; and country warnings. The weather data preferably further includes surface observation information; surface analysis weather maps; National Weather Service (NWS) forecasts; city forecasts; hurricane tracking; and surface wind speed and direction information.

As mentioned, the weather data is preferably geo-referenced so that it can be displayed in conjunction with the location data. More specifically, the weather data is associated with geographic coordinates, and each pixel or other image display element of the output display 38 is also associated with geographic coordinates, such that the displayed weather data can be positioned on the output display 38 to accurately reflect its actual geographic location. Thus, the weather data can be accurately overlayed onto street maps, topographic maps, aerial photographs, satellite photographs, and other geo-referenced images. The present invention preferably allows for larger scales than are normally needed for displaying navigation data on a GPS device in order to accommodate weather data with relatively large maximum resolutions and to display developing weather patterns that are more than a relatively short distance away from the user's current location. More specifically, NEXRAD Doppler weather radar has a range radius of 143 miles and a maximum resolution of 1 nautical mile, which may be greater than the minimum resolution of some navigation-related images. If the minimum resolution of the latter images is 8 meters per pixel, then, depending on the size of the output display, the total area displayable in a navigation context may be less than 1 square mile which would not allow for displaying developing weather patterns that are more than 1 mile away. Thus, the present invention preferably allows for appropriately larger scales of, for example, several miles, ten miles or multiples of ten miles, or even of one hundred miles or more, in order to allow for displaying anywhere between 10 square miles and 100 square miles or more of area at a time. It is contemplated that the display scale may change automatically to an appropriate scale depending on the type of information selected for display.

The internal weather data memory 51 is operable to store received weather data, including sequences of weather images, for later recall. The order in which the weather data is stored may be the order in which it was received, some other default order, or a user-definable order. Thus, for example, static Doppler radar images may be received and stored in sequence and then displayed in rapid succession in order to impart an illusion of movement or animation to any weather patterns appearing in the images.

The power supply 52 preferably includes a rechargeable battery. Because the weather data feature of the present invention may require more power than a conventional GPS device, the power supply 52 may be provided with appropriately greater capacity than would normally be expected in a conventional GPS device.

In one contemplated implementation of the GPS device 10, GPS navigation data may be updated with a frequency of once per minute or longer, and the GPS unit 30 may be powered-down, such as by entering a so-called “sleep mode”, at least during the periods between updates in order to conserve power. This implementation may allow for a scale suitable for displaying a 120 mile×80 mile area, or approximately 100 square miles, in order to better show relatively large or distant weather features. This implementation may also allow for an adjustable sequence of weather update images, with limited depth based on the capacity of the internal memory 51, and an adjustable sequence speed. Another contemplated implementation includes the aforementioned features and additional memory capacity, possibly in the form of removable cards, for storing longer weather sequences. This implementation may also allow for viewing other geographic regions and weather data for those regions. This implementation may also include a sound-making device, such as a buzzer, or even a small speaker for communicating audible weather alerts of severe weather and NOAA weather radio. Yet another contemplated implementation includes all of the aforementioned features in conjunction with enhanced GPS functionality.

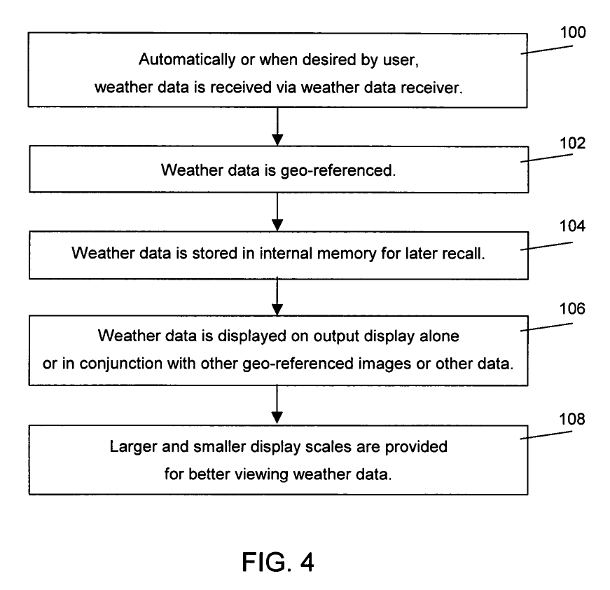

In exemplary and non-limiting use and operation, the GPS device 10 may function at least in part as follows. Referring to FIG. 4, automatically or when desired by the user, weather data is received via the weather data receiver 50, as indicated in box 100. The weather data is preferably automatically geo-referenced, as depicted in box 102. The weather data may be stored in the internal memory 51 and subsequently recalled for display, as depicted in box 104, possibly in the order it was received or in a user-defined sequence. The geo-referenced weather data can be displayed on the output display 38 in conjunction with other geo-referenced images or other data, including, for example, maps or photographs, as depicted in box 106. As necessary, the user can switch to a larger or smaller scale in order to better view the weather data, as depicted in box 108.

From the preceding discussion it will be appreciated that the GPS device and method of the present invention provide a number of substantial advantages over the prior art, including, for example, including, for example, allowing a user to access weather data while in the field, including detailed information regarding current and forecasted severe weather conditions that might pose a threat to the user's safety. This feature is fully adapted for and integrated into the GPS device, making it a less expensive, more rugged, more portable, and generally more appropriate and practical solution than is provided for by the prior art.

Although the invention has been described with reference to the preferred embodiments illustrated in the attached drawings, it is noted that equivalents may be employed and substitutions made herein without departing from the scope of the invention as recited in the claims.

Furthermore, it is contemplated that in some implementations of the device of the present invention the GPS functionality described herein may be minimized or eliminated in order to produce a device focused primarily or exclusively on providing weather data.

Having thus described the preferred embodiment of the invention, what is claimed as new and desired to be protected by Letters Patent includes the following:

1. A GPS device for accessing weather data, the device comprising:
a) a GPS unit including a GPS receiver and an antenna for receiving signals from each of a plurality of sources and, based on the received signals, determining a geographic location of the GPS device;
b) a weather data receiver for receiving weather data; and
c) an output display for displaying the geographic location and the weather data.

2. The GPS device as set forth in claim 1, further including a housing defining an internal area which is substantially sealable, wherein at least the GPS unit and the weather data receiver are substantially located within the internal area and enclosed within the housing.

3. The GPS device as set forth in claim 1, wherein the weather data receiver is a satellite radio receiver operable to receive the weather data from a satellite radio service.

4. The GPS device as set forth in claim 3, wherein the weather data receiver is operable to receive only a satellite radio channel which is a weather data channel.

5. The GPS device as set forth in claim 1, wherein the weather data receiver is a gsm/gprs telephone.

6. The GPS device as set forth in claim 1, wherein the weather data receiver is a satellite telephone.

7. The GPS device as set forth in claim 1, further including an internal memory for storing the weather data for subsequent recall and display.

8. The GPS device as set forth in claim 1, wherein the weather data is displayable on the output display on a scale of at least 25 square miles.

9. The GPS device as set forth in claim 8, wherein the weather data is displayable on the output display on a scale of at least 50 square miles.

10. The GPS device as set forth in claim 1, wherein the weather data includes Doppler radar data.

11. The GPS device as set forth in claim 10, wherein the weather data further includes one or more of the following: severe weather storm tracking; precipitation information; lightning information; country weather warnings; surface observation information; surface analysis weather maps; National Weather Service forecasts; city forecasts; hurricane tracking; and surface wind speed and direction information.

12. The GPS device as set forth in claim 1, wherein the weather data is geo-referenced.

13. The GPS device as set forth in claim 12, wherein the weather data is displayable simultaneous with and over the geographic location data.

14. A GPS device for accessing weather data, the device comprising:
a) a GPS unit including a GPS receiver and an antenna for receiving signals from each of a plurality of sources and, based on the received signals, determining a geographic location of the GPS device;
b) a weather data receiver for receiving weather data, wherein the weather data is geo-referenced and includes Doppler radar data;
c) an output display for displaying the geographic location and the weather data, wherein the weather data is displayable simultaneous with and over the geographic location data, and wherein the weather data is displayable on a scale of at least 25 square miles; and
d) a housing defining an internal area which is substantially sealable, wherein at least the GPS unit and the weather data receiver are substantially located within the internal area and enclosed within the housing.

15. The GPS device as set forth in claim 14, wherein the weather data receiver is a satellite radio receiver operable to receive the weather data from a satellite radio service.

16. The GPS device as set forth in claim 15, wherein the weather data receiver is operable to receive only a satellite radio channel which is a weather data channel.

17. The GPS device as set forth in claim 14, wherein the weather data is displayable on the output display on a scale of at least 50 square miles.

18. The GPS device as set forth in claim 14, wherein the weather data further includes one or more of the following: severe weather storm tracking; precipitation information; lightning information; country weather warnings; surface observation information; surface analysis weather maps; National Weather Service forecasts; city forecasts; hurricane tracking; and surface wind speed and direction information.

19. A weather data device for accessing weather data, the device comprising:
a) a weather data receiver for receiving the weather data;
b) an output display for displaying the weather data, wherein the weather data is displayable on a scale of at least 25 square miles; and
c) a portable, hand-holdable housing defining an internal area which is substantially sealable, wherein the weather data receiver is substantially located within the internal area.

20. The weather data device as set forth in claim 19, wherein the weather data receiver is a satellite radio receiver operable to receive the weather data from a satellite radio service.

21. The weather data device as set forth in claim 20, wherein the weather data receiver is operable to receive only a satellite radio channel which is a weather data channel.

22. The weather data device as set forth in claim 19, wherein the weather data receiver is a gsm/gprs telephone.

23. The weather data device as set forth in claim 19, wherein the weather data receiver is a satellite telephone.

24. The weather data device as set forth in claim 19, further including an internal memory for storing the weather data for subsequent recall and display.

25. The weather data device as set forth in claim 19, wherein the weather data includes Doppler radar data.

26. The weather data device as set forth in claim 19, wherein the weather data further includes one or more of the following: severe weather storm tracking; precipitation information; lightning information; country weather warnings; surface observation information; surface analysis weather maps; National Weather Service forecasts; city forecasts; hurricane tracking; and surface wind speed and direction information.

27. The weather data device as set forth in claim 19, wherein the weather data is geo-referenced.

28. The weather data device as set forth in claim 27, wherein the weather data is displayable simultaneous with and over other geo-referenced data.
